(19) United States
(12) Patent Application Publication
(10) Pub. No.: US 2025/0274558 A1
(43) Pub. Date: Aug. 28, 2025

(54) STORAGE MEDIUM, CONTROL METHOD, AND INFORMATION PROCESSING APPARATUS FOR STORING PROGRAM FOR CONVERTING COLOR GAMUT OF PRINT DATA INTO COLOR GAMUT REPRODUCIBLE IN PRINTING

(71) Applicant: CANON KABUSHIKI KAISHA, Tokyo (JP)

(72) Inventor: SOICHIRO YOSHIGI, Tokyo (JP)

(21) Appl. No.: 19/057,823

(22) Filed: Feb. 19, 2025

(30) Foreign Application Priority Data
Feb. 22, 2024 (JP) 2024-025508

(51) Int. Cl. H04N 1/60; G06F 3/12; H04N 1/50

(52) U.S. Cl. CPC H04N 1/6058; G06F 3/1205; G06F 3/1232; G06F 3/1253; H04N 1/50; H04N 1/6027; G06F 3/1225; G06F 3/1287

(57) ABSTRACT

A control method for converting color gamut of print data into color gamut reproducible in printing. A setting reception screen for receiving a setting of a color conversion function for converting a color gamut of print data to be printed by a printing device into a color gamut reproducible in printing by the printing device is displayed, and the color conversion function received on the setting reception screen is executed.

### BACKGROUND

### Field of the Disclosure

The present disclosure relates to a storage medium that stores a program, a control method, and an information processing apparatus.

### Description of the Related Art

A host computer (information processing apparatus) capable of processing information between with a printing device that performs printing is communicatively connected to the printing device. As control software for controlling the printing device, for example, a printer driver installed from the printing device in the host computer is used. With this printer driver, a print instruction can be issued from the host computer to the printing device. In the host computer, an operating system (hereinafter, referred to as “OS”) that is basic software is installed in advance. The printer driver has a configuration conforming to specifications defined by the OS, and can be called and operated by the OS. Furthermore, such a printer driver is different for each vendor that supplies a printing device, that is, a printer driver is specific to a model suitable for each printing device.

In recent years, Windows (registered trademark) has provided a standard class driver (hereinafter, sometimes referred to as a “standard driver”) that can be commonly used in printing devices supplied from each of a plurality of different vendors. Such a standard driver is incorporated in the OS in advance. Then, a standard driver can be used by connecting any printing device to a host computer having an OS in which the standard driver is incorporated. Accordingly, it is possible to omit installation of the printer driver specific to the model. Furthermore, the standard driver can specify and use a printing function in the printing device according to print device capabilities (hereinafter, referred to as “PDC”) generated on the basis of information acquired from the printing device. Thus, the printing function can be designated for each printing device with one standard driver. A function extensibility application (hereinafter, sometimes referred to as an “extensibility application”) that extends a function can be associated with the standard driver. The extensibility application is provided by each vendor. Therefore, it is difficult to execute the function of the extensibility application only with the standard driver.

Japanese Laid-Open Patent Publication (kokai) No. 2019-074906 discloses a support program used at the time of printing by a printer communicatively connected to an information processing apparatus.

However, the support program of Japanese Laid-Open Patent Publication (kokai) No. 2019-074906 cannot execute a color conversion function. As a result, it may not be possible to execute printing in consideration of the color gamut of the printing device.

### SUMMARY

Embodiments of the present disclosure provide a mechanism that enables execution of a color conversion function for converting a color gamut of print data to be printed in a printing device into a color gamut reproducible in printing by the printing device.

Embodiments of the disclosure provide a non-transitory computer-readable storage medium that stores a program for causing a computer to execute a control method, the program supporting a general-purpose program for generating data that is capable of being printed by a printing device manufactured by any one of a plurality of manufacturers, wherein the control method includes a display control step of displaying a setting reception screen for receiving a setting of a color conversion function for converting a color gamut of print data to be printed by the printing device into a color gamut reproducible in printing by the printing device, and an execution step of executing the color conversion function received on the setting reception screen.

According to embodiments of the present disclosure, a color gamut of print data to be printed by a printing device can be converted into a color gamut reproducible in printing by the printing device.

Further features of the present disclosure will become apparent from the following description of exemplary embodiments (with reference to the attached drawings).

### BRIEF DESCRIPTION OF THE DRAWINGS

FIG. 1 is a block diagram showing a hardware configuration of a printing system according to a first embodiment.

FIGS. 2AA and 2AB are block diagrams showing a software configuration of the printing system.

FIG. 2B is a diagram for explaining a color matching function.

FIG. 2C is a diagram showing an example of an LUT.

FIGS. 3A to 3D are diagrams showing an example of a screen displayed on a display unit of the printing system.

FIG. 4 is a flowchart showing processing in which a printing function extension unit edits printing function information.

FIG. 5 is a diagram showing an example of a list of capability information of the printing device.

FIG. 6 is a diagram showing an example of a list of printing functions supported by an extensibility application.

FIG. 7 is a diagram showing an example of a list of capability information of general-purpose printing software.

FIG. 8 is a sequence diagram showing processing executed among a drawing application, general-purpose printing software, an extensibility application, and a printing device after the drawing application accepts print settings.

FIG. 9 is a block diagram showing a software configuration of a printing system according to a second embodiment.

FIG. 10 is a flowchart showing processing in which the printing function extension unit edits printing function information.

FIG. 11 is a diagram showing an example of a list of capability information of the printing device.

FIG. 12 is a sequence diagram showing processing executed among a drawing application, general-purpose printing software, an extensibility application, and a printing device after the drawing application accepts print settings.

FIGS. 13A and 13B are diagrams showing an example of a screen displayed on a display unit of a printing system according to a third embodiment.

FIG. 14 is a diagram showing an example of a list of capability information of the printing device.

FIG. 15 is a view showing an example of a list of printing functions supported by the extensibility application.

### DESCRIPTION OF THE EMBODIMENTS

Hereinafter, each embodiment of the present disclosure will be described in detail with reference to the drawings. However, the configurations described in the following embodiments are merely examples, and the scope of the present disclosure is not limited by the configurations described in the embodiments. For example, each unit constituting embodiments of the present disclosure can be replaced with a unit having any configuration capable of exhibiting similar functions. In addition, any component may be added. Any two or more configurations (features) of the embodiments may be combined.

### First Embodiment

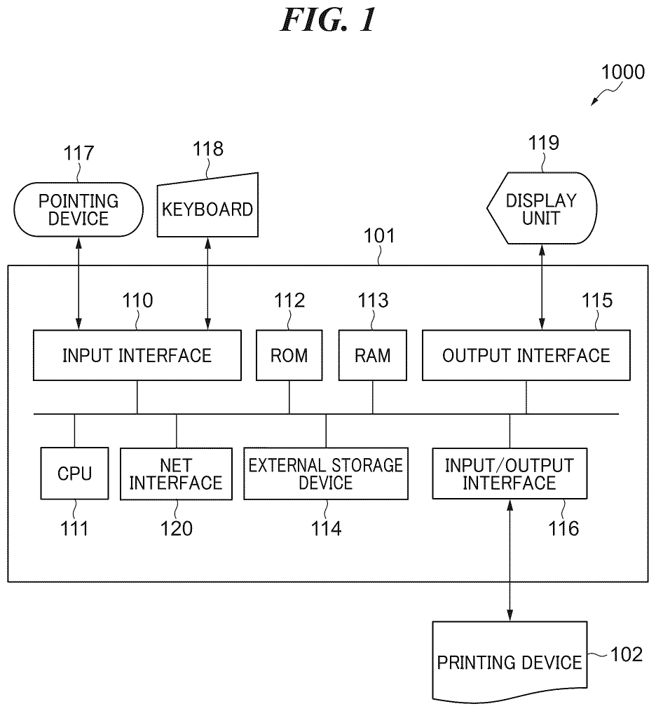

Hereinafter, a first embodiment will be described with reference to FIGS. 1 to 8.

### Hardware Configuration of Printing System

FIG. 1 is a block diagram showing a hardware configuration of a printing system according to the first embodiment. As shown in FIG. 1, the printing system 1000 includes a host computer 101, a printing device 102, a pointing device 117, a keyboard 118, and a display unit 119, which are communicatively connected to each other. The host computer 101 is an information processing apparatus, and includes an input interface 110, a CPU 111, a ROM 112, a RAM 113, an external storage device (storage medium) 114, an output interface 115, an input/output interface 116, and a NET interface 120. As the host computer 101, for example, a desktop personal computer can be used, but it is not limited thereto, and for example, a notebook personal computer, a tablet terminal, a smartphone, or the like can also be used.

The CPU 111 is a computer that executes programs and the like stored in the ROM 112 or the external storage device 114. The ROM 112 stores an initialization program. The external storage device 114 stores an application program group, an operating system (OS), print data generation software, and various other data. In the present embodiment, Windows (registered trademark) 11 of Microsoft (registered trademark) is installed as the OS in the host computer 101. The RAM 113 is used as a work memory or the like at the time of executing various programs stored in the external storage device 114, and various programs can be operated in the host computer 101. The pointing device 117 and the keyboard 118 as input devices are connected to the input interface 110. The display unit 119 as a display device is connected to the output interface 115. The display unit 119 displays, for example, a print setting screen 300A and a detailed setting screen 300C to be described below. The NET interface 120 is a network interface, and performs control for performing data transfer with an external device via a network. The printing device 102 is connected to the input/output interface 116. As a result, regardless of the manufacturer of the printing device 102, the host computer 101 can communicate with the printing device 102 manufactured by any one of a plurality of manufacturers, that is, can process information between with the printing devices 102 manufactured by any one of the plurality of manufacturers.

As the printing device 102, for example, a multi-function peripheral (MFP) having a plurality of functions such as copying, printing, and faxing can be used, but the present disclosure is not limited thereto. Furthermore, the printing performed by the printing device 102 is electrophotographic printing in the present embodiment, but is not limited thereto, and for example, printing of an inkjet method or the like can be used. In the present embodiment, the host computer 101 and the printing device 102 are configured as separate devices, but the present disclosure is not limited thereto. For example, the host computer 101 and the printing device 102 may be configured as an integrated device.

### Configuration of Printing System Centered on Software

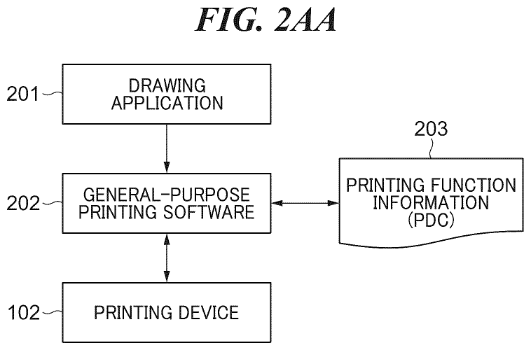

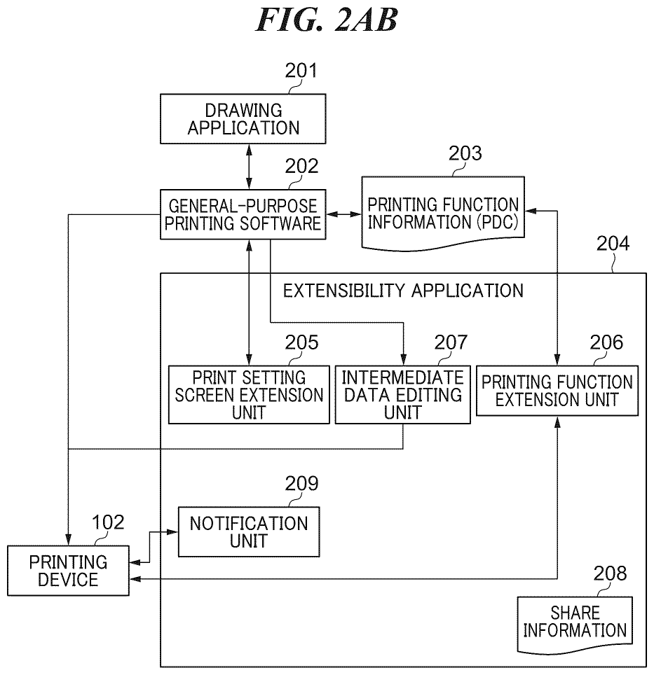

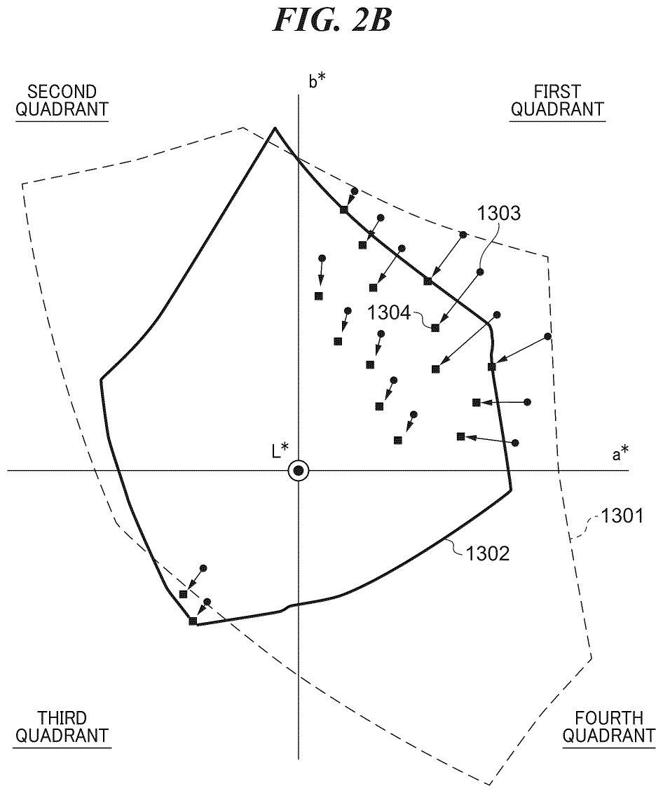

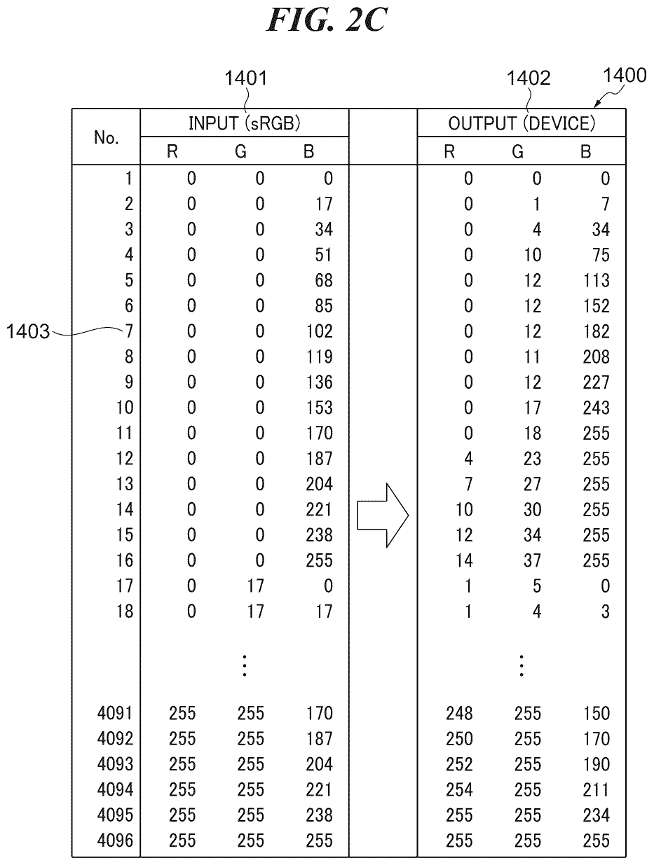

FIGS. 2AA and 2AB are block diagrams showing a software configuration of the printing system. FIG. 2AA is a diagram showing a general configuration in a case where the extensibility application (program) 204 is not associated with the general-purpose printing software (general-purpose program) 202 and the printing device 102. FIG. 2AB is a diagram showing a configuration in a case where the extensibility application 204 is associated with the general-purpose printing software 202 and the printing device 102. The general-purpose printing software 202 is a program that generates data that can be printed by the printing devices 102 manufactured by any one of a plurality of manufacturers, that is, can be commonly used at the time of printing for the printing device 102 manufactured by any one of the plurality of manufacturers, and is installed in the OS in advance. As the general-purpose printing software 202, a program that operates on the basis of internet printing protocol (IPP) is used. The extensibility application 204 is a program that supports, that is, assists the general-purpose printing software 202. In the present embodiment, the extensibility application 204 is an extension program (program for executing a control method) capable of extending a function that is not executable for the printing device 102 by the general-purpose printing software 202, but is not limited thereto. For example, the extensibility application 204 may be a program that improves convenience of functions that can be executed by the general-purpose printing software 202 for the printing device 102. The extensibility application 204 is stored, for example, in the external storage device 114 together with the OS (general-purpose printing software 202). As a result, the host computer 101 includes the general-purpose printing software 202 and the extensibility application 204.

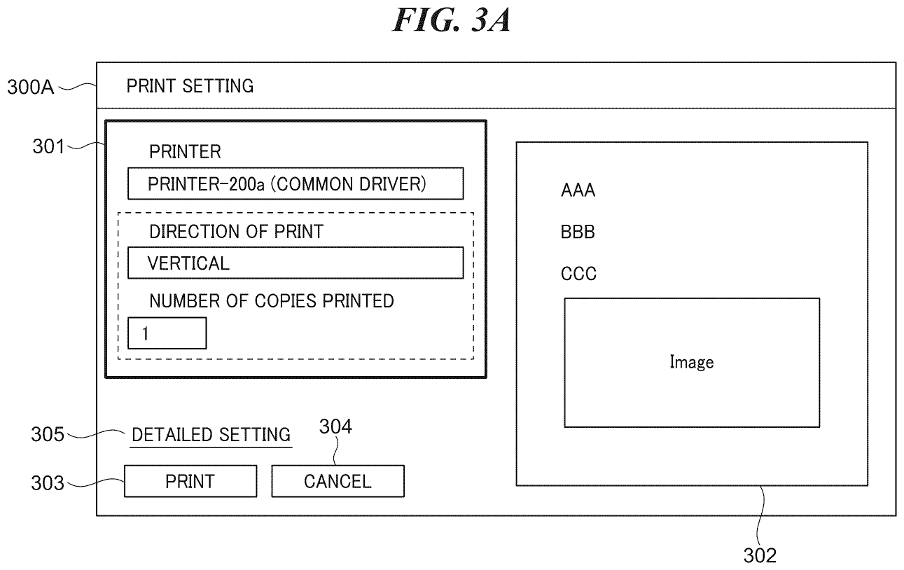

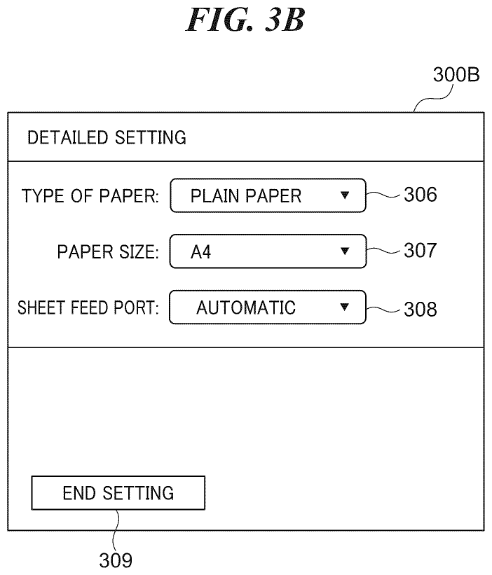

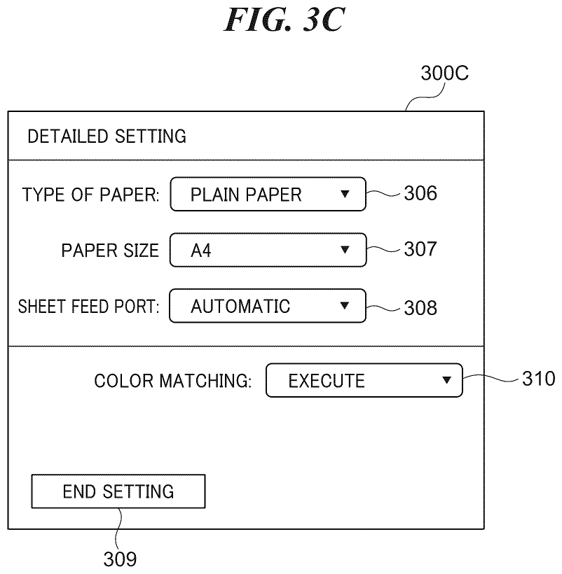

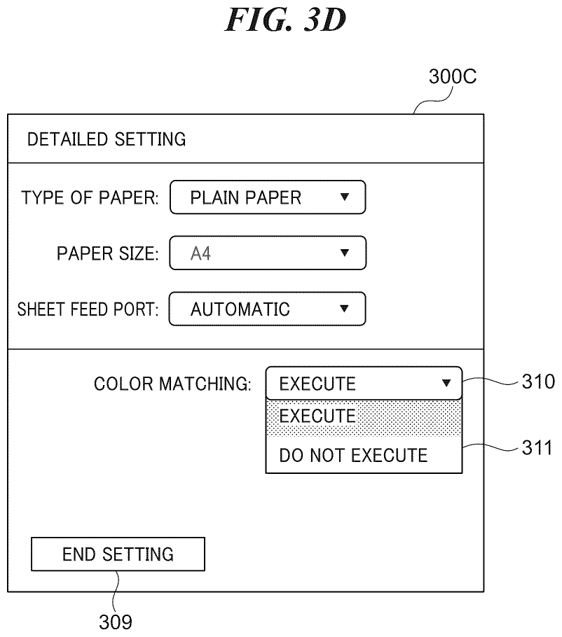

First, a configuration in a case where the extensibility application 204 is not associated with the general-purpose printing software 202 and the printing device 102 will be described with reference to FIG. 2AA. The drawing application 201 is software that creates content (print data) to be printed by the printing device 102. The drawing application 201 is not particularly limited, and examples thereof include a document creation application and a spreadsheet application. The drawing application 201 issues a print instruction to the OS by receiving a print request from the user via the keyboard 118, for example. The print instruction includes print setting information for instructing the operation of the general-purpose printing software 202 and the printing device 102. The print setting information is also called “print ticket (PT)”. In addition, the drawing application 201 can cause the display unit 119 to display the print setting screen 300A (see FIG. 3A) provided by any of the general-purpose printing software 202, the OS, and the drawing application 201 in order to output the print setting information. Further, when a control 305 in the print setting screen 300A is operated (pressed down), a detailed setting screen 300B (see FIG. 3B) or the detailed setting screen 300C (see FIG. 3C) can be displayed on the display unit 119. The print setting screen 300A to the detailed setting screen 300C will be described below. The print setting screen 300A includes a setting item indicating a settable printing function and a control item indicating a setting value thereof according to the capability information acquired from the general-purpose printing software 202, that is, information that can be set as print settings. The capability information is capability information regarding the capability of the printing device 102 to perform printing, and is also referred to as print capabilities (hereinafter, sometimes referred to as “PC”). It is also possible to determine whether or not the capability information includes information enabling display of the detailed setting screen 300C (determination step). Then, as a result of this determination, in a case where it is determined that the capability information includes information that enables display of the detailed setting screen 300C, the detailed setting screen 300C can be displayed. On the other hand, when it is determined that the capability information does not include information that enables display of the detailed setting screen 300C, the detailed setting screen 300C is not displayed.

The general-purpose printing software 202 determines the PC based on the printing function information 203. The printing function information 203 is data indicating printing functions for which all settable printing functions, setting values thereof, a mutual exclusion relationship between the setting values, and the like are listed. The printing function information 203 is also called print device capabilities (PDC). The printing function information 203 is included in the configuration file of the general-purpose printing software 202 and is placed in the external storage device 114 as an unmodifiable file. Alternatively, the printing function information 203 is dynamically generated by the general-purpose printing software 202. Specifically, the general-purpose printing software 202 acquires attribute data of the printing device 102 from the printing device 102. The general-purpose printing software 202 generates the printing function information 203 according to the attribute information in the attribute data. When the printing function information 203 is dynamically generated in this way, the printing function information 203 can be edited. Furthermore, the attribute data of the printing device 102 is a response acquired by issuing a “Get-Printer-Attributes” operation of IPP for the printing device 102. The response includes a function that can be specified by the printing device 102, that is, attribute information indicating the capability of the printing device 102, and a setting value related to the attribute information. The response is stored in the RAM 113.

With such a configuration, the general-purpose printing software 202 allows the user to designate the printing function available in the printing device 102 according to the printing device 102 connected to the general-purpose printing software 202. As a result, regardless of the printing device 102 connected to the general-purpose printing software 202, that is, even when a printing device having different functions or a printing device developed by a different printer manufacturer is connected, it is possible to designate a printing function available in the printing device. Note that, in the present embodiment, the general-purpose printing software 202 is configured to use an “IPP Class Driver” installed in Windows (registered trademark) 11. The “IPP Class Driver” is a printer driver that executes print processing in accordance with a standard print protocol specification called IPP, and is bundled with the OS package. The “IPP Class Driver” is not a specific printer driver corresponding to the model of the printing device 102, but is a standard class driver that can be commonly used in the printing device 102 of each printer manufacturer regardless of the printer manufacturer. Furthermore, the “IPP Class Driver” acquires the capability information of the printing device 102, and generates the printing function information 203 on the basis of the information.

The general-purpose printing software 202 can be associated with the extensibility application 204. As a result, functions that are not included in the general-purpose printing software 202 can be executed by the extensibility application 204. For example, the IPP Class Driver (general-purpose printing software 202) cannot execute a color matching function (color conversion function) based on a color gamut reproducible in the printing device 102 (hereinafter, sometimes referred to as a “color gamut of the printing device 102”). That is, the IPP Class Driver does not support execution of the color matching process. This is because the color matching function is a function executed independently by the printing device 102 manufactured by a predetermined printer manufacturer. The “color matching function” is a function of mapping an arbitrary color input from the host computer 101 (information processing apparatus) to another color space (color space of printing device) and converting the color to a desired color. With this color matching function, it is possible to use the color gamut of the printing device 102 to the maximum and maintain the gradation property in consideration of the color space of the printing device 102. Furthermore, depending on the color matching function, for example, it is also possible to match the color of the monitor or to make the color vivid. Thus, printing can be performed in consideration of the color gamut of the printing device. The extensibility application 204 can be extended to be able to execute color matching process that cannot be executed by the IPP Class Driver. In the present embodiment, the IPP Class Driver cannot execute the color matching process, and the extensibility application 204 can extend the color matching process to be executable, but the present disclosure is not limited thereto. For example, the IPP Class Driver may execute a part of the color matching process, and the extensibility application 204 may further extend the execution range by compensating for the shortage of the color matching process.

### Color Matching Function Based on Color Gamut of Printing Device

The color matching function based on the color gamut of the printing device 102 is a function of mapping (converting) the color of the input data (print data) into a color space that can be reproduced by the printing device 102. FIG. 2B is a diagram for describing a color matching function. FIG. 2B illustrates an a*b* plane in the L*a*b* color space, and on the a*b* plane, input data is represented by a general standard sRGB. Here, as an example, the input data is included in the color gamut 1301 of sRGB indicated by a broken line. It is assumed that most of the input data is mapped from the color gamut 1301 to the color gamut 1302 of the predetermined printing machine A indicated by a solid line. Furthermore, input data included in the color gamut 1301 and expressed in sRGB is indicated by a plurality of points 1303. Most of the plurality of points 1303 in the color gamut 1301 are mapped to the points 1304 in the color gamut 1302 by performing the color matching function. In particular, each point 1303 located in the first quadrant in FIG. 2B and located outside the color gamut 1302 needs to be converted into a color reproducible in the printing device 102, and thus is mapped so as to be necessarily compressed inside the color gamut 1302. Note that, at this time, even if the color gamut is narrowed by compression, mapping can be performed so as to maintain visual connection and gradation property between colors as much as possible. Furthermore, in the third quadrant in FIG. 2B, there is a portion where the color gamut 1301 is located inside the color gamut 1302. Each point 1303 in the color gamut 1301 in this portion is mapped so as to be enlarged toward the color gamut 1302 side.

### Execution Example of Color Matching Function Based on Color Gamut of Printing Device

Here, the color of the input data is RGB data including three channels of RGB that is generally used, and takes a value of 0 to 255 of 8 bits, but the present disclosure is not limited thereto. In addition, in the execution of the color matching function, a look up table (LUT) is used, but the present disclosure is not limited thereto. In the LUT, an input RGB signal value and an output RGB signal value are associated with each other. In the execution of the color matching function, RGB of the input data is converted into RGB of the color space of the printing device 102 with reference to the LUT. By using an interpolation operation such as tetrahedron interpolation, the LUT can be thinned out to reduce the table size, or any continuous value can be used for the input data. FIG. 2C is a diagram showing an example of the LUT. A LUT 1400 shown in FIG. 2C is a 16×16×16 LUT created by thinning out RGB signal values of 0 to 255 of 8 bits by 17 steps. An input 1401 is an sRGB color space, and an output 1402 is a color space of the printing device 102 (device). For example, when focusing on the point 1403, the point 1403 is converted from (0,0,102) in the sRGB color space to (0,12,182) in the color space of the printing device 102. Furthermore, even if a point (0,0,110) that is not on the input 1401 side is input, the point can be converted into an interpolation result of (0,11,191) by using, for example, tetrahedron interpolation.

Furthermore, since the RGB signal values of the input data do not take into consideration the color gamut of the printing device 102, there is a possibility that visual connection between colors is impaired or gradation property is deteriorated when printing is performed. Therefore, it is preferable to execute a color matching function that quickly and appropriately converts the RGB signal values of the input data in consideration of the color gamut of the printing device 102.

Here, the description returns to the description referring to FIG. 2AA. The OS generates intermediate data (sometimes referred to as “input data”) based on the print instruction output from the drawing application 201, and transmits the generated intermediate data to the general-purpose printing software 202. The data output by the drawing application 201 for printing is not particularly limited, and is preferably, for example, data in an XML paper specification format (XPS format). The data output for printing by the drawing application 201 may be data in a graphic device interface format (GDI format). When the IPP Class Driver is used as the general-purpose printing software 202, if the data output from the drawing application 201 is GDI format data, the OS converts the GDI format data into the XPS format data. Then, the OS transmits the converted XPS format data as intermediate data to the general-purpose printing software 202. When the data output from the drawing application 201 is data in the XPS format, the OS transmits the XPS format data as intermediate data to the general-purpose printing software 202. Note that the intermediate data includes drawing data that is information such as characters and figures formed on the print medium, and print setting information set by the user.

The general-purpose printing software 202 converts the intermediate data into print data (image data) that can be processed, that is, can be printed, by the printing device 102 and transmits the print data to the printing device 102. Here, the “print data” in the present embodiment is page description language (PDL) data conforming to IPP. The PDL data is, for example, data in a portable document format (PDF) or a PWG-Raster format. Note that the print data includes drawing data that is information such as characters and figures formed on the print medium, and print setting attribute information that is generated on the basis of print setting information set by the user and specifies print setting. The print setting attribute information includes attribute information indicating a function that can be designated by the printing device 102, that is, the capability of the printing device 102, and a setting value related to the attribute information.

The printing device 102 performs printing on the print medium based on the print data sent from the general-purpose printing software 202. At this time, the printing device 102 can form the drawing data included in the print data on the print medium by performing an operation according to the print setting attribute information included in the print data. The print setting attribute information includes, for example, print quality such as image quality priority and speed priority, attribute information for designating double-sided printing, single-sided printing, and the like, and a setting value of the attribute information. For example, in a case where the print setting attribute information includes attribute information designating double-sided printing, the printing device 102 can execute double-sided printing.

### When Extensibility Application is Associated

With reference to FIG. 2AB, a case in which the extensibility application 204 is associated with the general-purpose printing software 202 and the printing device 102 is described. As shown in FIG. 2AB, unlike FIG. 2AA, an extensibility application 204 is added. That is, the host computer 101 includes a drawing application 201, general-purpose printing software 202, and printing function information 203, and further includes an extensibility application 204. The extensibility application 204 is software for extending the functions of the general-purpose printing software 202. Note that the extensibility application 204 is software not included in the OS in advance (not bundled with the OS). Therefore, when the user operates the host computer 101, the extensibility application 204 is downloaded from a server (not shown) via the Internet and installed in the host computer 101. Alternatively, when the printing device 102 is connected to the host computer 101, the extensibility application 204 may be automatically installed in the host computer 101 on the basis of this connection. Specifically, when the printing device 102 is connected to the host computer 101, the OS acquires device identification information from the printing device 102. The OS may download and install the extensibility application 204 corresponding to the device identification information from the server via the Internet. As a result, the general-purpose printing software 202 and the extensibility application 204 are held as different control programs in the host computer 101. Note that the general-purpose printing software 202 and the extensibility application 204 may be updated and upgraded. Update process of the general-purpose printing software 202 and update process of the extensibility application 204 in this case may be performed at the same timing or may be performed at different timings. In addition, a trigger for acquiring the general-purpose printing software 202 by the host computer 101 and a trigger for acquiring the extensibility application 204 may be the same trigger or may be separate triggers. When the extensibility application 204 is installed, the OS associates the extensibility application 204 with the general-purpose printing software 202 and the printing device 102.

As shown in FIG. 2AB, the extensibility application 204 can exchange information (transmitting and receiving information) with the general-purpose printing software 202 and the printing device 102. That is, the extensibility application 204 is associated with the general-purpose printing software 202 and the printing device 102. In the present embodiment, the extensibility application 204 includes a print setting screen extension unit 205, a printing function extension unit 206, an intermediate data editing unit 207, and a notification unit 209. In addition, the extensibility application 204 has share information 208 accessible from each unit of the print setting screen extension unit 205, the printing function extension unit 206, the intermediate data editing unit 207, and the notification unit 209. The share information 208 is a file stored in the external storage device 114 or information stored in the RAM 113. The extensibility application 204 can write and read the share information 208 using an application program interface (API) provided by the OS.

Note that the extensibility application 204 may end the operation of the entire extensibility application 204 along with the end of the processing of each unit of the print setting screen extension unit 205 to the notification unit 209. In this case, the OS activates the extensibility application 204 every time a processing execution request of each unit is received. Further, for example, when the process of the print setting screen extension unit 205 is ended, the OS ends the operation of the entire extensibility application 204. Further, the extensibility application 204 may cancel the processing of each unit of the print setting screen extension unit 205 to the notification unit 209 during the processing. In this case, the job being processed on the print queue is deleted by the OS. As described above, the drawing application 201 issues a print instruction to the OS upon receiving a print request from the user. The drawing application 201 can also display a print setting screen. In the configuration shown in FIG. 2AB, the drawing application 201 can display a print setting screen 300A (detailed setting screen 300C) provided by the print setting screen extension unit 205 (extensibility application 204). Further, the print setting screen extension unit 205 can store the detailed settings set by the user in the share information 208. Details of the print setting screen extension unit 205 will be described below.

The intermediate data editing unit 207 obtains intermediate data from the general-purpose printing software 202. Then, the intermediate data editing unit 207 converts the intermediate data into print data, and then transmits the print data to the printing device 102. Further, the intermediate data editing unit 207 acquires detailed setting information from the share information 208, and adds the detailed setting to the print data. The printing device 102 performs printing on a paper surface based on the print data from the intermediate data editing unit 207. Note that the extensibility application 204 may be configured to acquire print data generated by the general-purpose printing software 202 and add detailed settings to the print data. In addition, even in the case of the configuration of FIG. 2AB, the color matching function may not be executed. In this case, the general-purpose printing software 202 may transmit the print data to the printing device 102 without passing through the extensibility application 204.

The printing function extension unit 206 can edit the printing function information 203 (PDC) generated by the general-purpose printing software 202 or the OS. As a result, it is possible to add a function provided by the extensibility application 204. Furthermore, addition of a function (for example, color matching function) that can be executed by the printing device 102 but cannot be executed by the general-purpose printing software 202, addition of an exclusive relationship between set values of printing functions, and the like can also be performed. The OS activates the printing function extension unit 206 when the extensibility application 204 is first associated with the printing device 102 and the general-purpose printing software 202. In addition, the OS may activate the printing function extension unit 206 at other timings (for example, at the time of starting the OS). Even when the function related to printing is extended later by such activation, the printing function extension unit 206 can detect the extended function and add the detected function to the printing function information 203. As an example in which the function related to printing is extended later, an optional device (for example, a finisher or the like) may be added later to the printing device 102.

When an error occurs in the printing device 102, the notification unit 209 can notify the occurrence of the error. For example, when a paper-out error occurs in the printing device 102, the general-purpose printing software 202 detects the occurrence of the error. The OS causes the display unit 119 to display, as a message, occurrence of a paper-out error, which is a detection result in the general-purpose printing software 202, by a notification function called a toast notification, which is one of the functions of the OS. Note that when the user operates the toast notification, the notification unit 209 is called by the OS, and a user interface screen (UI screen) of the notification unit 209 is displayed. The user interface screen can display, for example, a detailed message regarding the paper-out error, a paper filling method, and the like.

As described above, in the present embodiment, the extensibility application 204 can be said to have the following four functions. The first function is a function of displaying a setting screen. This function is executed by the print setting screen extension unit 205. The second function is a function of editing the intermediate data, converting the intermediate data into the print data, and adding the detailed settings to the print data. This function is performed in the intermediate data editing unit 207. The third function is a function of extending a function that can be specified by the print data generation software. This function is performed by the printing function extension unit 206. A fourth function is a function of displaying a screen in response to the occurrence of an error in the printing device 102. This function is performed in the notification unit 209. Note that the configuration of the extensibility application 204 is not limited to the configuration having these four functions, and is preferably a configuration having at least one function, and may be a configuration having another function. Furthermore, once the print data is transmitted to the printing device 102, the extensibility application 204 cannot display a screen of a guide or the like associated with the print data in the middle of processing of each unit.

### Example of Print Setting Screen/Detailed Setting Screen

FIG. 3 is a diagram showing an example of a screen displayed on the display unit of the printing system. FIG. 3A is a print setting screen displayed by the drawing application 201. FIG. 3B is a detailed setting screen displayed in a case of a configuration in which the extensibility application 204 is not associated. FIG. 3C is a detailed setting screen displayed in the case of the configuration associated with the extensibility application 204. Note that a unit and a module that display each screen are not particularly limited. For example, the print setting screen extension unit 205 may be configured to only generate a display screen. In this case, the print setting screen extension unit 205 transmits the generated display screen to the drawing application 201 via the general-purpose printing software 202. The drawing application 201 may be configured to display the acquired display screen.

A print setting screen 300A shown in FIG. 3A is a screen on which print conditions related to printing in the printing device 102 can be set. The print setting screen 300A includes a control (button) 301, a control 302, a control 303, a control 304, and a control 305. In the control 301, the printing device 102 used for printing, the printing direction in the printing device 102, and the number of copies printed in the printing device 102 can be set. In FIG. 3A, as an example, the printing device 102 used for printing is set to “printer 200a”, the printing direction in the printing device 102 is set to “vertical”, and the number of copies printed in the printing device 102 is set to “1”. In the control 302, a preview screen is displayed. The control 303 can instruct the printing device 102 to start printing. The control 304 can instruct the printing device 102 to cancel printing. In the control 305, detailed settings can be made.

When the control 305 is operated in the configuration in which the extensibility application 204 is not associated, the detailed setting screen 300B shown in FIG. 3B is displayed. The detailed setting screen 300B includes a control 306, a control 307, a control 308, and a control 309. The control 306 can select and set the type of paper to be used for printing by the printing device 102. In FIG. 3B, “plain paper” is selected as an example. The control 307 can select and set a paper size used for printing by the printing device 102. In FIG. 3B, “A4” is selected as an example. In the control 308, a sheet feed port of a paper used for printing in the printing device 102 can be selected. In FIG. 3B, “automatic” is selected as an example. In the control 309, the setting in the control 306 to the control 308 can be ended. Further, by operating the control 309, the screen returns to the print setting screen 300A shown in FIG. 3A.

By operating the control 305 in the case of the configuration associated with the extensibility application 204, the detailed setting screen (setting reception screen) 300C shown in FIG. 3C is displayed (display control step). The detailed setting screen 300C is a screen displayed together with the print setting screen 300A, but a display mode thereof is not particularly limited. For example, the detailed setting screen 300C may be displayed so as to overlap the print setting screen 300A, the detailed setting screen 300C may be displayed adjacent to the print setting screen 300A, or the detailed setting screen 300C may be displayed after the print setting screen 300A temporarily disappears. The detailed setting screen 300C includes a control 306, a control 307, a control 308, and a control 309, similarly to the detailed setting screen 300B. Further, the detailed setting screen 300C additionally includes a control 310. The control 310 can receive a setting of a color matching function that converts a color gamut of print data to be printed by the printing device 102 into a color gamut reproducible in printing by the printing device 102. The list 311 is displayed by operating the control 310 (see FIG. 3D). The list 311 is a selection part by using which whether to execute the color matching function is to be selected as one of the settings of the color matching function. The list 311 includes “execute (execute color matching function)” and “do not execute (not to execute color matching function)”, and in FIG. 3D, “execute” is selected as an example.

Here, the reason why the items included in the detailed setting screen 300B shown in FIG. 3B are different from the items included in the detailed setting screen 300C shown in FIG. 3C will be described. The detailed setting screen 300B and the detailed setting screen 300C are generated on the basis of the printing function information (capability information). As described above, the general-purpose printing software 202 does not support execution of the color matching function. Therefore, the color matching function cannot be added to the printing function information only with the general-purpose printing software 202. Even if the printing function information originally includes the color matching function, the general-purpose printing software 202 cannot interpret the color matching function included in the printing function information. Therefore, the setting of the color matching function cannot be displayed on the detailed setting screen. Therefore, the printing function extension unit 206 adds a color matching function to the printing function information 203. Then, the print setting screen extension unit 205 displays the detailed setting screen 300C with reference to the capability information. As a result, the extensibility application 204 can display the setting of the color matching function on the detailed setting screen.

### Flowchart of Printing Function Extension Unit for Editing Printing Function Information

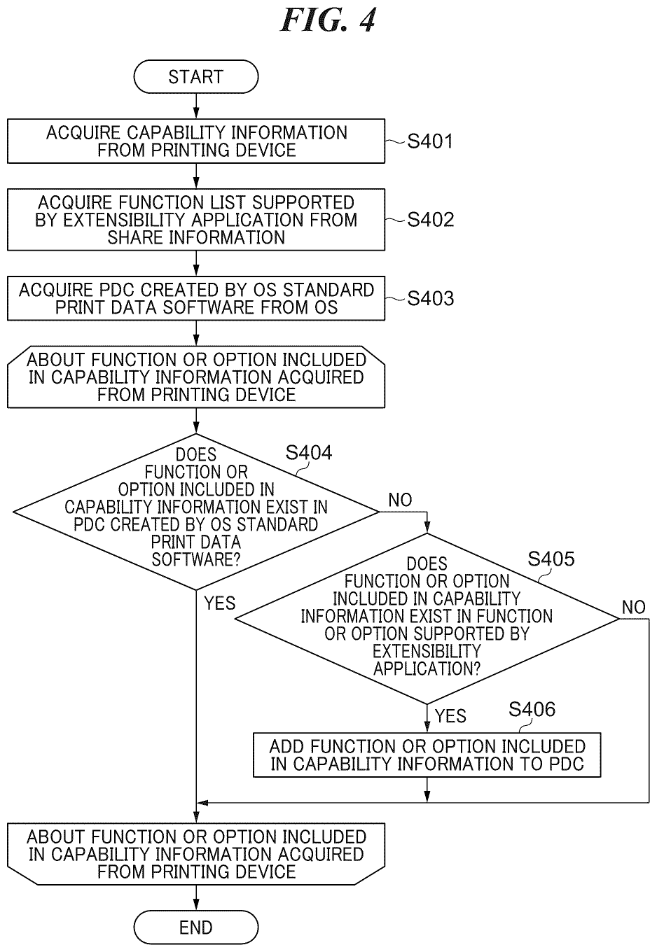

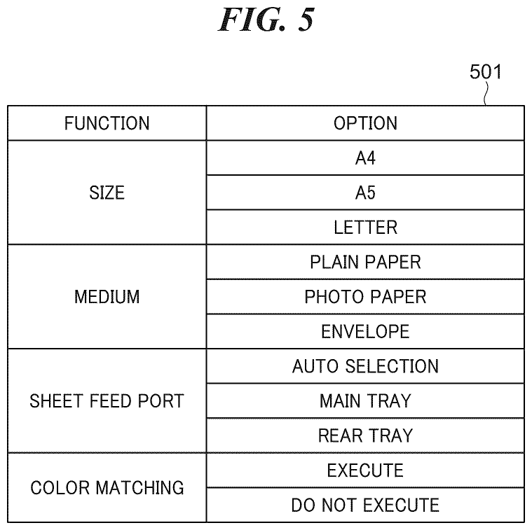

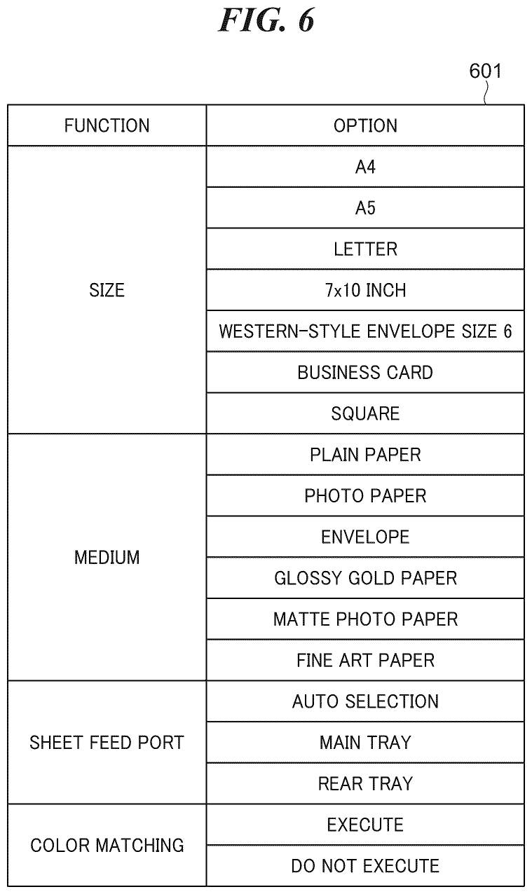

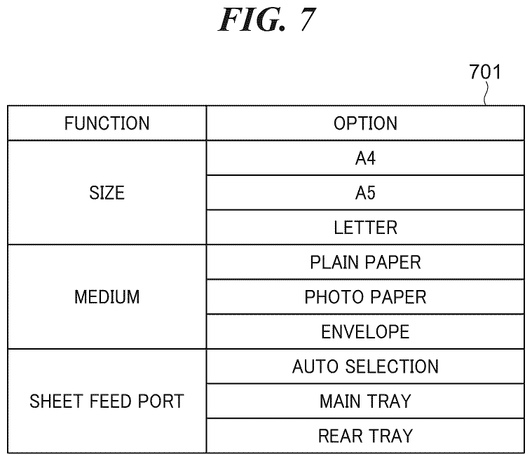

FIG. 4 is a flowchart showing a process in which the printing function extension unit edits printing function information. Note that the program based on the flowchart shown in FIG. 4 is executed by the CPU 111 controlling the printing function extension unit 206. FIG. 5 is a diagram showing an example of a list of the capability information of the printing device. FIG. 6 is a diagram showing an example of a list of the printing functions supported by the extensibility application. FIG. 7 is a diagram showing an example of a list of the capability information of the general-purpose printing software. As shown in FIG. 4, in step S401, the printing function extension unit 206 acquires the capability information from the printing device 102 (acquisition step). The capability information is a setting value included in a response acquired by issuing a “Get-Printer-Attributes” operation of IPP to the printing device 102. The set value is related to attribute information indicating a function that can be designated by the printing device 102 and the attribute information. Table 501 shown in FIG. 5 shows a list of the capability information of the printing device 102. The capability information includes, for example, information related to the size of paper used for printing by the printing device 102. In addition, there are information related to the type of paper (medium) used for printing by the printing device 102, information related to the sheet feed port of the paper used for printing by the printing device 102, and information related to the color matching function executable by the printing device 102. Note that the information regarding the color matching function includes “execute (execute color matching function)” and “do not execute (not to execute color matching function)” described above.

In step S402, the printing function extension unit 206 acquires the printing function supported by the extensibility application 204 from the share information 208. The share information 208 stores a list of printing functions supported by the extensibility application 204. Then, this list includes all the printing functions that can be processed by the extensibility application 204 and the set values thereof. Table 601 shown in FIG. 6 includes information regarding the size of paper supported by the extensibility application 204 as the printing function. In addition, there are information related to the paper type supported by the extensibility application 204, information related to the sheet feed port of the paper supported by the extensibility application 204, and information related to the color matching function supported by the extensibility application 204. Note that the information regarding the color matching function includes “execute (execute color matching function)” and “do not execute (not to execute color matching function)”, as in Table 501. Further, the printing function supported by the extensibility application 204 may be updated by updating the extensibility application 204 or the like.

In step S403, the printing function extension unit 206 acquires the printing function information 203 created by the general-purpose printing software 202 from the OS. The printing function information 203 is created based on the capability information 501 acquired by the general-purpose printing software 202 from the printing device 102. The printing function information 203 (PDC) created by the general-purpose printing software 202 includes only the printing function supported by the general-purpose printing software 202 in the capability information acquired from the printing device 102. For example, Table 601 shown in FIG. 6 includes “7×10 inches” and “Yokei No. 6 (western-style envelope size 6)” as the paper sizes, but the general-purpose printing software 202 does not support the corresponding paper size. Therefore, the printing function information 203 does not include the corresponding paper size. Table 601 shown in FIG. 6 includes information on the color matching function, but the general-purpose printing software 202 does not support the color matching function. Therefore, the printing function information 203 does not include the color matching function. The printing function extension unit 206 adds functions and options to the printing function information 203, so that the extensibility application 204 can compensate for the lack of functions of the general-purpose printing software 202. The printing function extension unit 206 can also delete unnecessary functions and options from the printing function information 203 created by the general-purpose printing software 202.

Steps S404, S405, and S406 are processes repeatedly performed on the function list included in the capability information acquired from the printing device 102 in step S401. In the present embodiment, steps S404, S405, and S406 are repeatedly performed for all 11 options included in Table 501.

In step S404, the printing function extension unit 206 determines whether the function or option currently being processed exists in the printing function information 203 generated by the general-purpose printing software 202. As a result of the determination in step S404, in a case where it is determined that the function or the option exists in the printing function information 203, when the last item among the options is being processed, the processing ends. Alternatively, if the last item in the options is not being processed, the next item in the options is selected and step S404 is executed again. On the other hand, as a result of the determination in step S404, when it is determined that the function or the option does not exist in the printing function information 203, the process proceeds to step S405. For example, in the present embodiment, Table 501 includes the paper size “A4”, and Table 701 also includes the paper size “A4”. In this case, in step S404, it is determined that the function or option currently being processed exists in the printing function information 203. On the other hand, Table 501 includes “execute (execute color matching function)”, but Table 701 does not include “execute (execute color matching function)”. In this case, in step S404, it is determined that the function or option currently being processed does not exist in the printing function information 203.

In step S405, the printing function extension unit 206 determines whether or not the function (option) currently being processed exist in the functions (options) supported by the extensibility application 204. As a result of the determination in step S405, in a case where it is determined that the function currently being processed exists, the processing proceeds to step S406. On the other hand, as a result of the determination in step S405, in a case where it is determined that the function currently being processed does not exist, similarly to the case where it is determined as “Yes” in step S404, if the last item in the options is being processed, the processing ends. Alternatively, if the last item in the options is not being processed, the next item in the options is selected and step S404 is executed again. For example, in the present embodiment, when the function currently being processed is “execute (execute color matching function)”, the “execute (execute color matching function)” also exists in Table 601. Therefore, in step S405, it is determined that a function currently being processed exists.

In step S406, the printing function extension unit 206 adds the currently processed function (option) to the printing function information 203. After the execution of step S406, similarly to the case where it is determined as “Yes” in step S404, if the last item in the options is being processed, the process ends. Alternatively, if the last item in the options is not being processed, the next item in the options is selected and step S404 is executed again.

As described above, the extensibility application 204 can add, to the printing function information 203, a function (option) that is not compatible with the general-purpose printing software 202, is compatible with the printing device 102, and is compatible with the extensibility application 204. Then, the capability information (PC) is generated on the basis of the printing function information 203 edited by the addition process. Further, the print setting screen extension unit 205 can extend a function that is not supported by the general-purpose printing software 202 by generating a display screen on the basis of the capability information, and can display the detailed setting screen 300C shown in FIG. 3C.

Processing after Drawing Application Accepts Print Setting

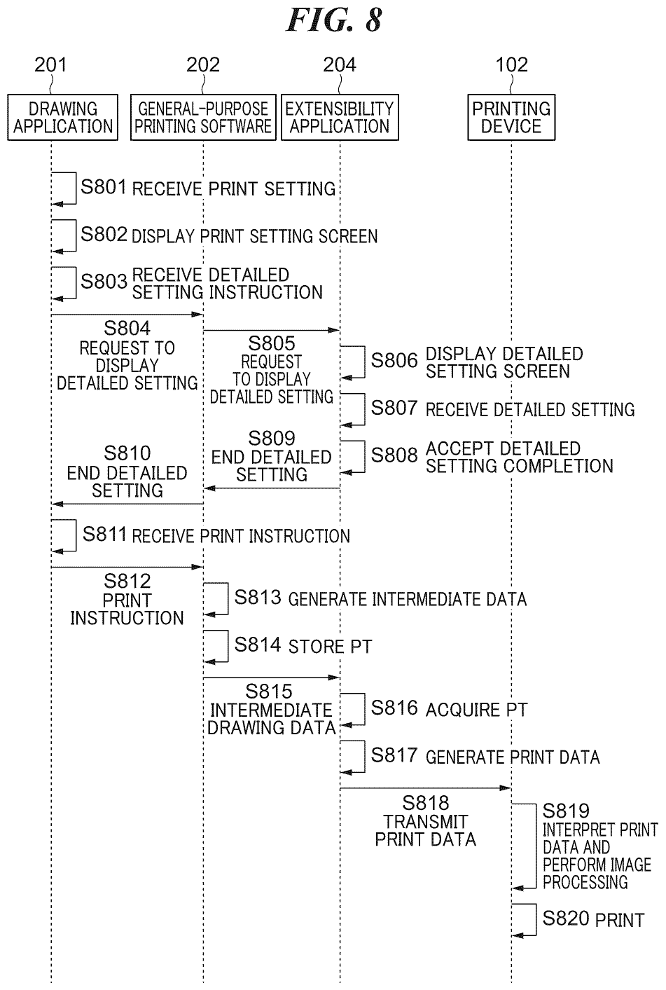

FIG. 8 is a sequence diagram showing processing executed among the drawing application, the general-purpose printing software, the extensibility application, and the printing device after the drawing application receives the print setting. Processing in the drawing application, the general-purpose printing software, and the extensibility application is executed by the CPU 111 of the host computer 101. This processing program is stored in the external storage device 114. Then, the CPU 111 reads the processing program from the external storage device 114 to the RAM 113 and executes the processing program. The processing in the printing device 102 is executed by a CPU (not shown) of the printing device 102. The software configuration of the printing system 1000 is the software configuration shown in FIG. 2AB.

As shown in FIG. 8, in step S801, the drawing application 201 receives print settings by the user. The user can instruct the drawing application 201 to perform print setting by operating the pointing device 117 or the keyboard 118, for example.

In step S802, the drawing application 201 displays the print setting screen 300A shown in FIG. 3A on the display unit 119.

In step S803, the drawing application 201 receives a detailed setting instruction from the user. For example, the user can instruct detailed settings by operating the pointing device 117 or the keyboard 118 and selecting the control 305 on the print setting screen 300A.

In step S804, the drawing application 201 requests the general-purpose printing software 202 to display detailed settings.

In step S805, the general-purpose printing software 202 requests the extensibility application 204 to display the detailed settings.

In step S806, the print setting screen extension unit 205 of the extensibility application 204 displays the detailed setting screen 300C of FIG. 3C. As described above, the printing function extension unit 206 adds a color matching function to the printing function information 203 (PDC). The print setting screen extension unit 205 can display the detailed setting screen 300C with reference to the capability information (PC) generated on the basis of the added printing function information 203.

In step S807, the print setting screen extension unit 205 receives the detailed settings on the detailed setting screen 300C by the user. Here, as an example, it is assumed that, on the detailed setting screen 300C, the paper type “plain paper” is selected on the control 306, the paper size “A4” is selected on the control 307, and the sheet feed port “automatic” is selected on the control 308 (see FIG. 3C). It is also assumed that “execute (execute color matching function)” is selected in the control 310. In this setting state, the print setting screen extension unit 205 receives an operation of the control 309 of the detailed setting screen 300C by the user.

In step S808, the print setting screen extension unit 205 accepts that the detailed settings by the user have been completed based on the operation of the control 309 in step S807. The user can instruct to end the detailed settings, for example, by operating the pointing device 117 or the keyboard 118 to select the control 309.

In step S809, the extensibility application 204 transmits the detailed setting end information indicating the end of the detailed setting in step S808 to the general-purpose printing software 202.

In step S810, the general-purpose printing software 202 receives the detailed setting end information transmitted from the extensibility application 204 in step S809. The general-purpose printing software 202 transmits the detailed setting end information to the drawing application 201.

In step S811, the drawing application 201 receives a print instruction from the user. The user can issue the print instruction by, for example, operating the pointing device 117 or the keyboard 118 and selecting the control 303 on the print setting screen 300A (see FIG. 3A).

In step S812, the drawing application 201 issues the print instruction received in step S811 to the general-purpose printing software 202.

In step S813, the general-purpose printing software 202 generates the intermediate data based on the print instruction in step S812 using the module of the OS.

In step S814, the general-purpose printing software 202 stores the print setting information (PT) based on the print instruction in step S812 in the share information 208.

In step S815, the general-purpose printing software 202 transmits the drawing data among the intermediate data generated in step S813 to the extensibility application 204.

In step S816, the intermediate data editing unit 207 of the extensibility application 204 acquires the stored print setting information in step S814 from the share information 208.

In step S817, the intermediate data editing unit 207 of the extensibility application 204 generates print data using the drawing data transmitted in step S815 and the print setting information acquired in step S816. This print data has been converted into data including the color matching function setting received on the detailed setting screen 300C (conversion step).

In step S818, the intermediate data editing unit 207 of the extensibility application 204 transmits the print data generated in step S817 to the printing device 102 (transmission step). The print data includes setting information of the color matching function received on the detailed setting screen 300C.

In step S819, the printing device 102 receives the print data transmitted in step S818. The printing device 102 interprets the print data and performs necessary image processing on the print data. As the image processing here, execution of a color matching function, that is, color matching process is performed.

In step S820, the printing device 102 prints the print data subjected to the image processing in step S819. As a result, the print product takes the color space of the printing device 102 into consideration, that is, the color gamut of the printing device 102 is used to the maximum, and the gradation property is maintained, as compared with the case where the color matching process is not performed.

As described above, in the printing system 1000, even in a case where the general-purpose printing software 202 does not support the color matching process, the extensibility application 204 can cause the printing device 102 to execute the color matching process. As a result, the print product that has been subjected to (reflected on) the color matching process is printed from the printing device 102. In the description with reference to FIG. 8, the detailed setting screen 300C shown in FIG. 3C is displayed assuming that the software configuration of the printing system 1000 is the software configuration shown in FIG. 2AB, but the present disclosure is not limited thereto. For example, in a case where the display request of the detailed settings is made to the general-purpose printing software 202 in step S804, the general-purpose printing software 202 displays the detailed setting screen 300B shown in FIG. 3B. In this case, after the operation of the control 309 on the detailed setting screen 300B, the general-purpose printing software 202 requests the extensibility application 204 to display an additional detailed setting screen. Next, the extensibility application 204 may additionally display a detailed setting screen on which the color matching function can be set. In the present embodiment, the extensibility application 204 generates the print data from the intermediate data generated by the general-purpose printing software 202, but the present disclosure is not limited thereto, and for example, the extensibility application 204 itself may generate the intermediate data.

### Second Embodiment

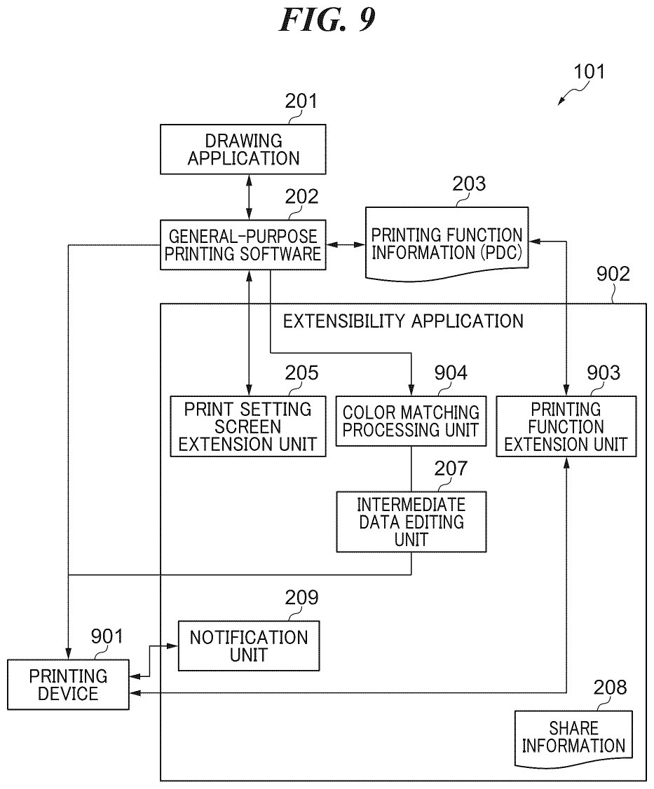

Hereinafter, a second embodiment will be described with reference to FIGS. 9 to 12, but differences from the above-described embodiment will be mainly described, and description of similar matters will be omitted. In the first embodiment, the extensibility application 204 generates print data including the color matching function setting together with the general-purpose printing software 202. This print data is transmitted to the printing device 102. The printing device 102 can interpret the print data including the color matching function setting and execute the color matching process. As described above, in the first embodiment, the extensibility application 204 causes the printing device 102 to execute the color matching process together with the general-purpose printing software 202.

However, depending on the printing device 102, there is a printing device that cannot execute color matching process. In this case, even if the extensibility application 204 generates print data including the color matching function setting, it is not possible to cause the printing device 102 to perform the color matching process. In a case where the printing device 102 cannot execute the color matching process, it is preferable to generate print data for which the color matching process has been executed on the extensibility application 204 side and transmit the print data to the printing device 102.

Therefore, in the present embodiment, it is determined whether or not the color matching process can be executed in the printing device 102 on the basis of the capability information of the printing device 102. As a result of this determination, in a case where it is determined that the color matching process can be executed in the printing device 102, print data reflecting the color matching function setting is generated on the extensibility application 204 side and transmitted to the printing device 102. On the other hand, when it is determined that the color matching process cannot be executed in the printing device 102, the extensibility application 204 generates print data on which the color matching process has been executed for the drawing data, and transmits the print data to the printing device 102. As a result, even in a case where the color matching process cannot be executed in the printing device 102, the color matching function can be provided to the user. Note that the present embodiment is similar to the first embodiment except that the configuration of the printing system 1000 when the extensibility application 204 is associated, the PDC editing process, and the process after the drawing application 201 receives the print setting are different.

### Configuration of Printing System Centered on Software

FIG. 9 is a block diagram showing a software configuration of a printing system according to a second embodiment. The block diagram shown in FIG. 9 is a diagram showing a configuration in a case where the extensibility application 902 is associated with the general-purpose printing software 202 and the printing device 102. As shown in FIG. 9, the host computer 101 includes a drawing application 201, general-purpose printing software 202, printing function information 203, and an extensibility application 902. The extensibility application 902 is communicably connected to a printing device 901. Unlike the printing device 102 in the first embodiment, the printing device 901 is a printing device that cannot execute color matching process. The extensibility application 902 includes a print setting screen extension unit 205, an intermediate data editing unit 207, a notification unit 209, a printing function extension unit 903, and a color matching processing unit 904. The printing function extension unit 903 can add the color matching function to the printing function information 203 even in a case where it is determined that the color matching process cannot be executed in the printing device 102 on the basis of the capability information acquired from the printing device 901. The color matching processing unit 904 performs color matching process on the intermediate data (drawing data) from the general-purpose printing software 202 on the basis of the color matching function setting set by the user.

### Flowchart of Printing Function Extension Unit for Editing Printing Function Information

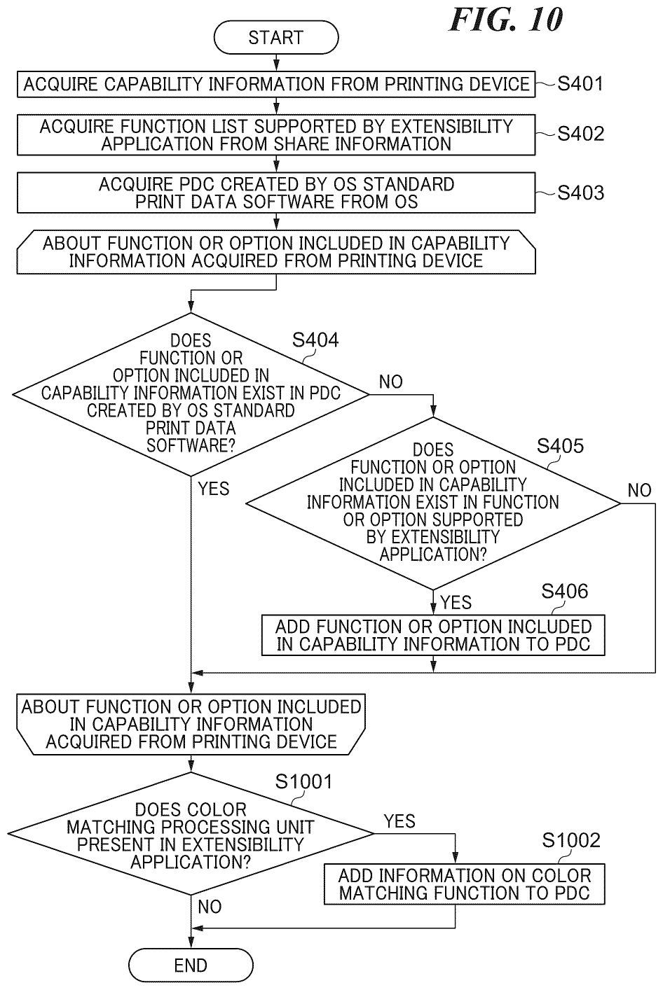

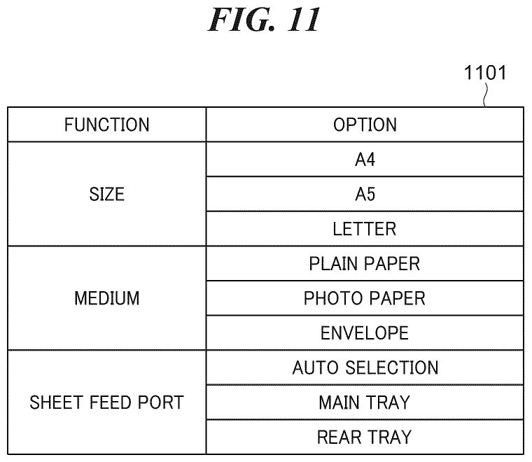

FIG. 10 is a flowchart showing a process in which the printing function extension unit edits printing function information. Note that the program based on the flowchart shown in FIG. 10 is executed through control of the printing function extension unit 903 by the CPU 111. In addition, the flowchart shown in FIG. 10 is a flowchart in which steps S1001 and S1002 are added to the flowchart shown in FIG. 4. FIG. 11 is a diagram showing an example of a list of the capability information of the printing device. As shown in FIG. 10, in a case where the repetitive processing of steps S404 to S406 is completed, the processing proceeds to step S1001. Table 1101 shown in FIG. 11 shows a list of the capability information of the printing device 901. Table 1101 includes information related to the size of the paper, information related to the type of paper, and information related to the sheet feed port of the paper as the capability information, but does not include information related to the color matching function unlike Table 501 shown in FIG. 5. Therefore, it can be seen that the printing device 901 cannot execute the color matching process. Therefore, the color matching function is not added to the printing function information 203 after the processing in steps S404 to S406 is completed.

As shown in FIG. 10, in step S1001, the printing function extension unit 903 determines whether or not the color matching processing unit 904 is present in the extensibility application 902, that is, whether or not the color matching processing unit 904 exists. As a result of the determination in step S1001, in a case where it is determined that the color matching processing unit 904 exists, the processing proceeds to step S1002. On the other hand, as a result of the determination in step S1001, in a case where it is determined that the color matching processing unit 904 does not exist, the process ends. As described above, since the extensibility application 902 includes the color matching processing unit 904, the processing proceeds to step S1002.

In step S1002, the printing function extension unit 903 adds information regarding the color matching function in Table 501 shown in FIG. 5, that is, “execute” and “do not execute” to the printing function information 203.

As described above, the extensibility application 902 can add, to the printing function information 203, a function (option) that is not compatible with the general-purpose printing software 202, is compatible with the printing device 102, and is compatible with the extensibility application 204. Then, the extensibility application 902 determines the presence or absence of the color matching processing unit 904. As a result of this determination, in a case where it is determined that the color matching processing unit 904 exists, the color matching function is added to the printing function information 203. By this addition process, even when the printing device 901 cannot execute the color matching process, the capability information is generated on the basis of the printing function information 203 to which the color matching function is added. The extensibility application 902 can display the detailed setting screen 300C shown in FIG. 3C by generating the display screen on the basis of the capability information.

Processing after Drawing Application Accepts Print Setting

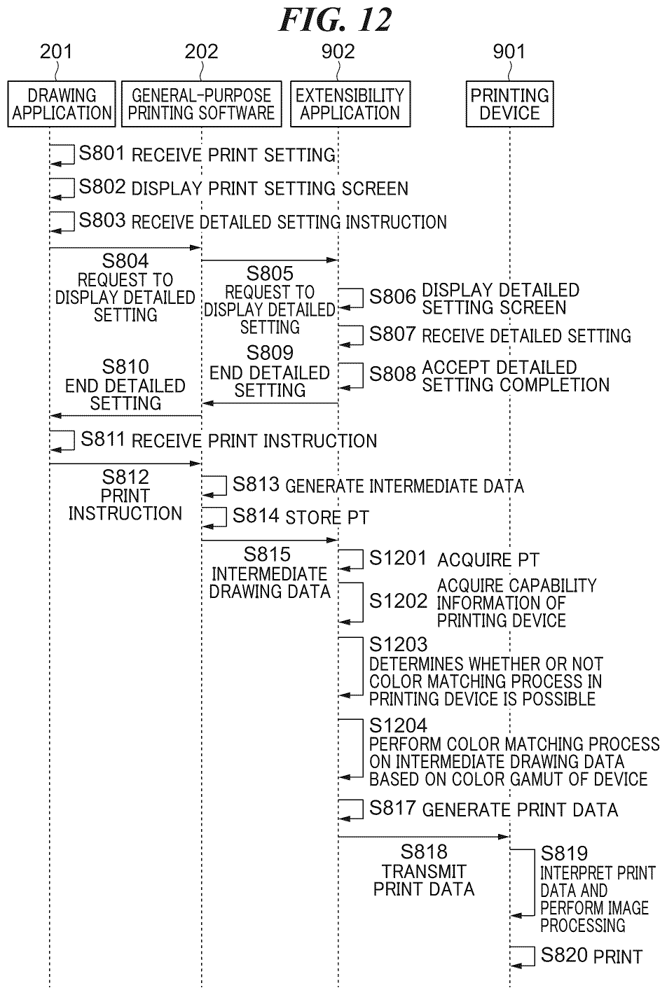

FIG. 12 is a sequence diagram showing processing executed among the drawing application, the general-purpose printing software, the extensibility application, and the printing device after the drawing application receives the print setting. The sequence diagram shown in FIG. 12 is a sequence diagram in which steps S1201 to S1204 are mainly added to the sequence diagram shown in FIG. 8. As shown in FIG. 12, after execution of step S815, the process proceeds to step S1201. In step S1201, the color matching processing unit 904 of the extensibility application 902 acquires the print setting information (PT) stored in step S814 from the share information 208. Furthermore, the color matching processing unit 904 acquires information regarding the color matching function setting included in the print setting information.

In step S1202, the color matching processing unit 904 acquires the capability information of the printing device 901 from the share information 208. When the capability information of the printing device 901 is not included in the share information 208, the printing function extension unit 903 may request the capability information from the printing device 901. Also in this case, the capability information is stored in the share information 208.

In step S1203, the color matching processing unit 904 determines whether or not color matching process in the printing device 901 is possible on the basis of the capability information acquired in step S1202. As described above, in the present embodiment, the printing device 901 is a printing device that cannot perform color matching process. Therefore, in the determination result in step S1203, it is determined that the color matching process in the printing device 901 is impossible. Note that, as a result of the determination in step S1203, in a case where it is determined that the color matching process in the printing device 901 is possible, the process skips step S1204 and proceeds to step S817. This is because the printing device 901 can perform the color matching process at a higher speed than the color matching processing unit 904. Specifically, this is because the printing device 901 can perform processing at a higher speed than the color matching processing unit 904 by using an application specific integrated circuit (ASIC).

In step S1204, the color matching processing unit 904 performs color matching process (execution step) on the intermediate drawing data (intermediate data) on the basis of the information regarding the color matching function setting acquired in step S1201. The processing result is stored in the share information 208. Furthermore, the color matching processing unit 904 edits the color matching function of the print setting information to “do not execute”, and deletes the information regarding the color matching function setting from the print setting information. After execution of step S1204, the processing proceeds in order from step S817 to step S820. Note that the print data transmitted in step S818 reflects the execution result obtained by executing the color matching process in step S1204. Then, the print product obtained in step S820 is a print product on which the color matching process has been executed, that is, a print product in which the color gamut of the printing device 102 is used to the maximum and the gradation property is maintained.

As described above, in the present embodiment, even in a case where the color matching process cannot be executed by the printing device 901, the extensibility application 902 can execute the color matching process. As a result, the print product subjected to the color matching process is also printed by the printing device 901.

### Third Embodiment

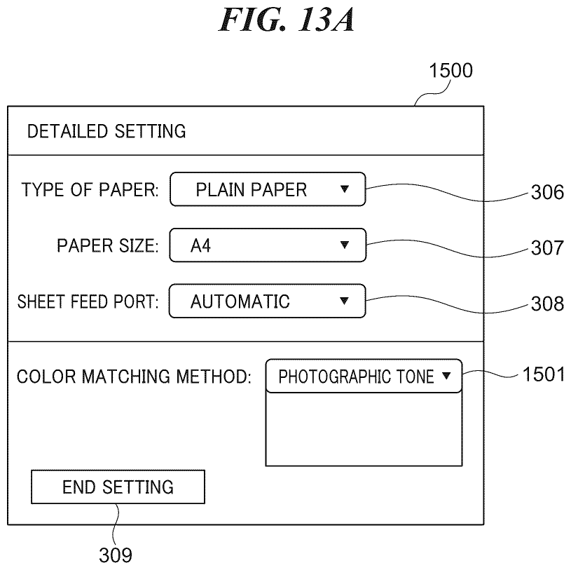

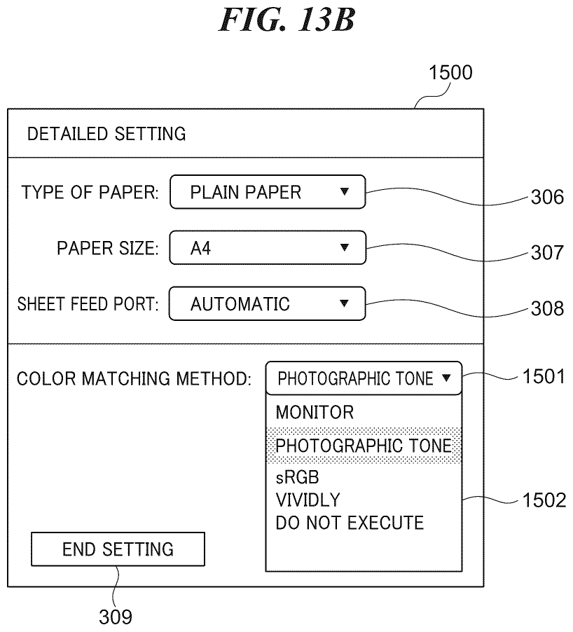

Hereinafter, a third embodiment will be described with reference to FIGS. 13A to 15, but differences from the above-described embodiment will be mainly described, and description of similar matters will be omitted. In the first embodiment, the color matching process is executed in consideration of the color gamut of the printing device 102. As a result, the color gamut of the printing device 102 is used to the maximum, and a print product in which the gradation property is maintained can be printed. On the other hand, for example, the user may desire that the print product matches the reproduction color of the display unit 119 or is vividly reproduced on the display unit 119. In the host computer 101, it is preferable that color matching process suitable for such a case can be executed.

### Example of Detailed Setting Screen

FIGS. 13A and 13B are diagrams showing an example of a screen displayed on the display unit of the printing system according to the third embodiment. The detailed setting screen 1500 shown in FIG. 13A is a detailed setting screen displayed in a case of a configuration in which the extensibility application 204 is associated. The detailed setting screen 1500 includes a control 306, a control 307, a control 308, and a control 309, similarly to the detailed setting screen 300C. The detailed setting screen 1500 additionally includes a control 1501. The list 1502 is displayed by operating the control 1501 (see FIG. 13B). The list 1502 includes “monitor”, “photographic tone”, “sRGB”, and “vividly” as settings of the color matching function, and further includes “do not execute (not to execute color matching function)”, and one of these can be selected. In the list 1502 in FIG. 3D, “photographic tone” is selected as an example. Note that the list 1502 is not limited to including all of “monitor”, “photographic tone”, “sRGB”, “vividly”, and “do not execute (not to execute color matching function)”, and may include at least one of them.

By selecting “monitor”, the color matching process is executed such that the print product approaches the reproduction color of the display unit 119. As described above, the “monitor” functions as a color tone adjustment part, by using which the color tone of the printing portion of the print product to which the execution result of the color matching function is reflected is adjusted so as to approach the reproduction color of the display unit 119. By selecting “photographic tone”, the color matching process is executed so that the gradation property can be maintained. As described above, the “photographic tone” functions as a gradation adjustment part, by using which gradation is adjusted through executing color matching process. By selecting “sRGB”, the color matching process is executed so that the print product approaches the color of sRGB. As described above, “sRGB” functions as a color tone adjustment part, by using which the color tone of the printing portion of the print product to which the execution result of the color matching function is reflected is adjusted so as to approach the color of sRGB. By selecting “vividly”, the color matching process is executed so that saturation can be maintained. As described above, “vividly” functions as a saturation adjustment part, by using the saturation adjustment part, saturation is adjusted through execution of the color matching function.

### Example of Capability Information of Printing Device/Printing Function Supported by Extensibility Application

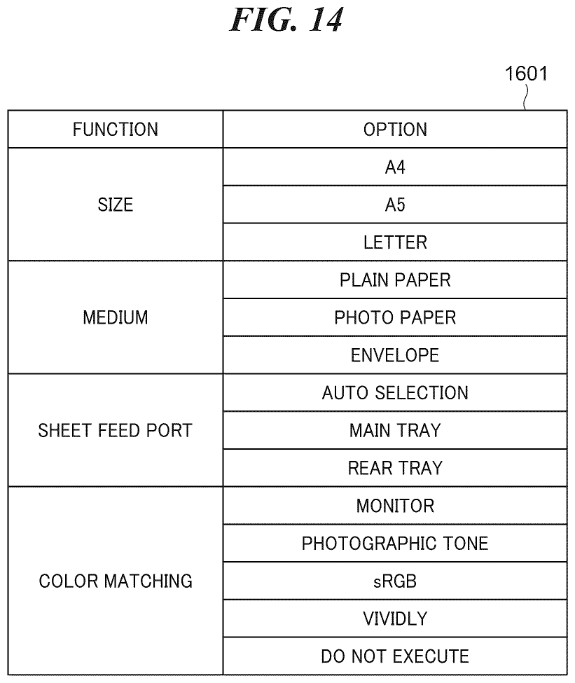

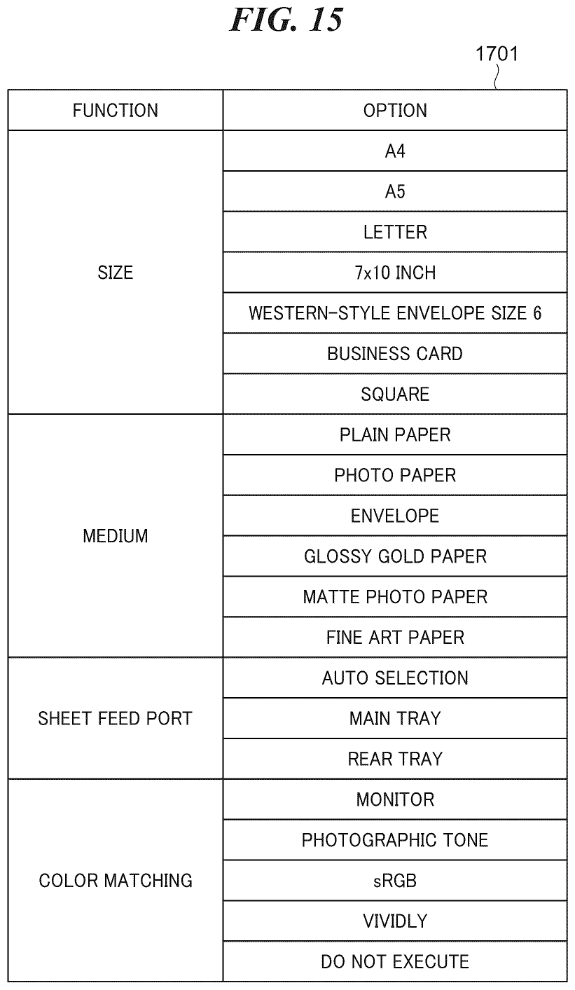

FIG. 14 is a diagram showing an example of a list of the capability information of the printing device. Table 1601 shown in FIG. 14 shows a list of the capability information of the printing device 102. The capability information includes information related to a size of paper, information related to a type of paper, information related to a sheet feed port of the paper, and information related to a color matching function. Note that the information regarding the color matching function includes “monitor”, “photographic tone”, “sRGB”, “vividly”, and “do not execute (not to execute color matching function)” described above. FIG. 15 is a diagram showing an example of a list of printing functions supported by the extensibility application. Similarly to Table 1601, Table 1701 shown in FIG. 15 includes, as printing functions, information related to a size of paper, information related to a type of paper, information related to a sheet feed port of paper, and information related to a color matching function. Similarly to Table 1601, the information about the color matching function includes “monitor”, “photographic tone”, “sRGB”, “vividly”, and “do not execute (not to execute color matching function)” described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-025508, filed Feb. 22, 2024, which is hereby incorporated by reference herein in its entirety.

What is claimed is:

1. A non-transitory computer-readable storage medium that stores a program for causing a computer to execute a control method, the program supporting a general-purpose program for generating data that is capable of being printed by a printing device manufactured by any one of a plurality of manufacturers, wherein
the control method comprises:
a display control step of displaying a setting reception screen for receiving a setting of a color conversion function for converting a color gamut of print data to be printed by the printing device into a color gamut reproducible in printing by the printing device; and
an execution step of executing the color conversion function received on the setting reception screen.

2. The non-transitory computer-readable storage medium according to claim 1, wherein
in the execution step, the color conversion function according to the setting of the color conversion function received on the setting reception screen is executed on the data generated by the general-purpose program.

3. The non-transitory computer-readable storage medium according to claim 2, further comprising:
a transmission step of transmitting an execution result in the execution step to the printing device,
wherein
in the printing device, the execution result transmitted in the transmission step is capable of being reflected in the print product printed by the printing device.

4. The non-transitory computer-readable storage medium according to claim 1, further comprising:
an acquisition step of acquiring capability information regarding a capability of the printing device to perform printing from the printing device prior to the display control step; and
a determination step of determining whether or not the capability information acquired in the acquisition step includes information enabling display of the setting reception screen,
wherein in the display control step, the setting reception screen is displayed when it is determined that the information enabling display of the setting reception screen is included in the capability information as a result of the determination in the determination step, and the setting reception screen is not displayed when it is determined that the information enabling display of the setting reception screen is not included in the capability information.

5. The non-transitory computer-readable storage medium according to claim 1, wherein
in the display control step, the setting reception screen is displayed together with a print setting screen on which a print condition regarding printing in the printing device is capable of being set.

6. The non-transitory computer-readable storage medium according to claim 1, wherein
the setting reception screen includes a selection part by using which whether to execute the color conversion function is to be selected as the setting of the color conversion function.

7. The non-transitory computer-readable storage medium according to claim 1, wherein
the setting reception screen includes as the setting of the color conversion function a saturation adjustment part, by using which saturation is adjusted through execution of the color conversion function.

8. The non-transitory computer-readable storage medium according to claim 1, wherein
the setting reception screen includes as the setting of the color conversion function a gradation adjustment part, by using which gradation is adjusted through execution of the color conversion function.

9. The non-transitory computer-readable storage medium according to claim 1, wherein
the setting reception screen includes, as a setting of the color conversion function, a color tone adjustment part, by using which a color tone of a printing portion of print product is adjusted, the print product printed by the printing device and an execution result of the color conversion function being reflected to the print product.

10. The non-transitory computer-readable storage medium according to claim 1, wherein
the color conversion function is a function that cannot be executed on the printing device by the general-purpose program.

11. The non-transitory computer-readable storage medium according to claim 1, wherein
a program that operates based on an internet printing protocol (IPP) is used as the general-purpose program.

12. A control method for performing control supporting a general-purpose program for generating data that is capable of being printed by a printing device manufactured by any one of a plurality of manufacturers, the control method comprising:
a display control step of displaying a setting reception screen for receiving a setting of a color conversion function for converting a color gamut of print data to be printed by the printing device into a color gamut reproducible in printing by the printing device; and
an execution step of executing the color conversion function received on the setting reception screen.

13. An information processing apparatus that is communicatively connected to a printing device manufactured by any one of a plurality of manufacturers and is capable of processing information between with the printing device, the information processing apparatus comprising:
a general-purpose program that generates data that is capable of being printed by the printing device manufactured by any one of a plurality of manufacturers; and
a program that supports the general-purpose program and causes a computer to execute a control method,
wherein the control method comprises:
a display control step of displaying a setting reception screen for receiving a setting of a color conversion function for converting a color gamut of print data to be printed by the printing device into a color gamut reproducible in printing by the printing device; and
an execution step of executing the color conversion function received on the setting reception screen.
